(19) United States
(12) Patent Application Publication
(10) Pub. No.: US 2010/0173591 A1
(43) Pub. Date: Jul. 8, 2010

(54) METHOD AND DEVICE FOR ALTERNATELY ALLOCATING BASE-STATION SIGNALS TO A LIMITED NUMBER OF CHANNELS OF A TEST DEVICE

(75) Inventors: Rolf Huber, Fuerstenfeldbruck (DE); Stephan Sandhaeger, Germering (DE); Walter Schatz, Hoehenkirchen (DE)

Correspondence Address: DITTHAVONG MORI & STEINER, P.C., 918 Prince Street, Alexandria, VA, 22314, US

(73) Assignee: Rohde & Schwarz GmbH & Co. KG, Muenchen (DE)

(21) Appl. No.: 12/665,974

(22) PCT Filed: May 13, 2008
(86) PCT No.: PCT/EP08/03812

§ 371 Date: Dec. 22, 2009

(30) Foreign Application Priority Data
Jun. 27, 2007 (DE) 10 2007 029 718.3
Feb. 21, 2008 (DE) 10 2008 010 300.4

(51) Int. Cl. H04B 17/00

(52) U.S. Cl. 455/67.11

(57) ABSTRACT

A method for testing a mobile radio device in a real test scenario, using a test device in which signal sequences, typical of mobile telephony, of a plurality of base stations are produced. The signal sequence of one base station each is allocated to one of the plurality of send/receive channels of the test device. The signal sequence of at least one of the plurality of base stations is alternatively allocated to at least one of the plurality of send channels of the test device and the signals sent back from the mobile device to be tested are evaluated.

### CROSS-REFERENCE TO RELATED APPLICATION

The present application is a national phase application of PCT Application No. PCT/EP2008/003812, filed on May 13, 2008, and claims priority to German Application No. 10 2007 029 718.3, filed on Jun. 27, 2007, and German Application No. 10 2008 010 300.4, filed on Feb. 21, 2008, the entire contents of which are herein incorporated by reference.

### BACKGROUND OF THE INVENTION

1. Field of the Invention

The invention relates to a method and a system for testing mobile-radio devices and, in particular, a method for allocating and replaying signal sequences of several base stations recorded in real radio scenarios to a limited number of channels of a test device in a temporal alternating manner.

2. Discussion of the Background

Methods and devices for testing mobile-radio devices are known from the prior art. In this context, a test network is generated in that one or more transmission channels of the test device transmit signals according to the mobile-radio standard to be tested and therefore model one or more base stations of the mobile radio network.

The mobile-radio device under test receives the signals, interprets and processes them and sends back response signals, which are picked up by the reception part of the test device. The test device interprets these and compares them with the anticipated values and signals. The communication between mobile-radio devices and base station can also be initiated by the mobile-radio device, so that the base station becomes the responding component. The evaluation can relate to different functions of the mobile-radio device. Accordingly, the functionality and quality of the radio transmission components of the mobile-radio device can be checked by analyzing the bit-error rate. A measurement method of this kind and a corresponding device are described in DE 10 2005 048 448 A1.

Conversely, the signalization messages communicated in the radio signal can be evaluated. In the mobile radio standards, a precise sequence of signalization messages is specified for every interaction of the subscriber or respectively of the mobile-radio device with the mobile radio network, for example, for booking in to a new radio cell or notification of the location. The test device prepares the signalisation messages from the received radio signals of the mobile-radio device and compares their content and their time sequence with the anticipated characteristic.

The testing of the mobile-radio devices with regard to a standardized behaviour as described above is implemented several times during the development and production of mobile-radio devices. The signal sequences used for the test are conventionally prepared in the laboratory from signal components.

For the user of mobile telephones and accordingly also for the network operator and mobile telephone manufacturer, the error-free operation of a mobile-radio device within the real network is of primary importance. In this context, as a result of the superposition of signal sequences of several base stations, considerably more complex radio fields are present than in the case of the test methods and testing devices described above. Testing the behaviour of a mobile-radio device in a real network is referred to as an interoperability test.

Interoperability tests are implemented either in special laboratories of the network-infrastructure manufacturer or within the real field with all the conditions predominating there. These tests are very expensive as a result of the rental of test networks, and a case of error can no longer be reproduced as a result of continuously-varying marginal conditions, such as transmission power and loading of the base stations.

As a result, the signal sequences of the base stations are preferably recorded in a real network using a test mobile-radio device and/or special radio test devices, such as network scanners. Test mobile-radio devices or prepared mobile-radio devices within the sense of the present invention are generally mobile-radio devices, which have messages and data, which are exchanged in a regular network operation via the radio interface between the mobile-radio device and the base section, at their disposal via an interface for the output of information. Furthermore, data, which relate to further radio-channel information, are communicated via the same interface. For the subsequent testing of a mobile-radio device under test, the recorded signal sequences of the base stations are then allocated to the transmission channels of the test device and replayed.

Since the number of recorded base stations is generally greater than the number of the physical transmission channels on the test device, the real radio field can only be reproduced in an incomplete manner.

### SUMMARY OF THE INVENTION

Embodiments of the invention advantageously provide a method and a system, which allows the testing of mobile-radio devices under the most real radio conditions possible, in which signal sequences from any required number of base stations can be replayed by the test device.

With the method according to the invention, in the first method step, signal sequences of several base stations, which correspond with a mobile-radio standard or a mobile-radio specification, are prepared. In this context, the number of prepared base-station signal sequences exceeds the number of transmission channels in the test device. In a second step, the signal sequence of, in each case, exactly one of the several base stations is allocated to each of the several transmission channels of the test device. In order to replay the signal sequences of a relatively large number of base stations in the test device, the allocation of the signal sequence of at least one of the several base stations to at least one of the several transmission channels of the test device is alternated, in a third step, after the expiry of a defined time or in the presence of another alternation criterion. In the fourth step, the test device receives and analyzes the signals transmitted back from the mobile-radio device under test.

It is particularly advantageous to record the mobile-radio-specific signal sequences of the base stations of an existing radio field during a test run by means of radio network analyzer and/or test mobile-radio device and to prepare the signal sequences of the base stations for the test device from these. Alternatively, the signal sequences can also be recorded in a laboratory interoperability test. Instead of the signal sequences, the instruction sequence to be worked through by the test device for this purpose can also be used for the processing and allocation of the signal sequences to be issued.

For the sake of simplicity, only the term “signal sequence” will be used below as a general term.

It is particularly advantageous to select the signal sequences of individual base stations from the totality of the recorded signal sequences and mark them according to their significance. The signal sequence of a base station of high significance is preferably allocated to one of several transmission channels. As a result, particularly important base stations can be emphasised. “High significance” can be allocated, for example, in the presence of a high transmission power. Accordingly, in each case, the signal sequences of the base stations with the most powerful signals are generated by the test device.

Furthermore, it is advantageous to change parts of the signal sequences of individual base stations, for example, in order to implement parameter modifications. Moreover, entire signalisation procedures are added, if these are not contained in the recorded signal sequence or are unusable.

It is particularly advantageous to transmit the signal sequences from the transmission channel with the recorded signal power and in the recorded time sequence.

The recorded signal sequences can correspond, for example, to the GSM, UMTS standard WiMax, LTE or an other standard.

One particularly advantageous system comprises an interface with a radio network analyzer and/or a test mobile-radio device, a read-in unit for reading in and storage of the signal sequences from several base stations, a transmission and reception unit with several transmission and reception channels and an allocation unit, which allocates the signal sequence in each case to a base station or an instruction sequence generated by it to at least one of the several transmission channels. The temporal alternation of the allocation between base-station signal sequence and transmission channel is controlled by an alternating unit. The messages transmitted back from the mobile-radio device are now analysed in the evaluation unit.

### BRIEF DESCRIPTION OF THE DRAWINGS

One preferred embodiment of the invention is presented in the drawings and explained in greater detail below. The drawings are as follows:

FIG. 1 shows a presentation of a mobile radio test procedure according to the method of the invention using the device according to the invention, and

FIG. 2 shows the schematic presentation of a possible temporal alternating allocation of the signal sequences of the base stations to the transmission channels of the test device.

### DETAILED DESCRIPTION OF EXEMPLARY EMBODIMENTS OF THE INVENTION

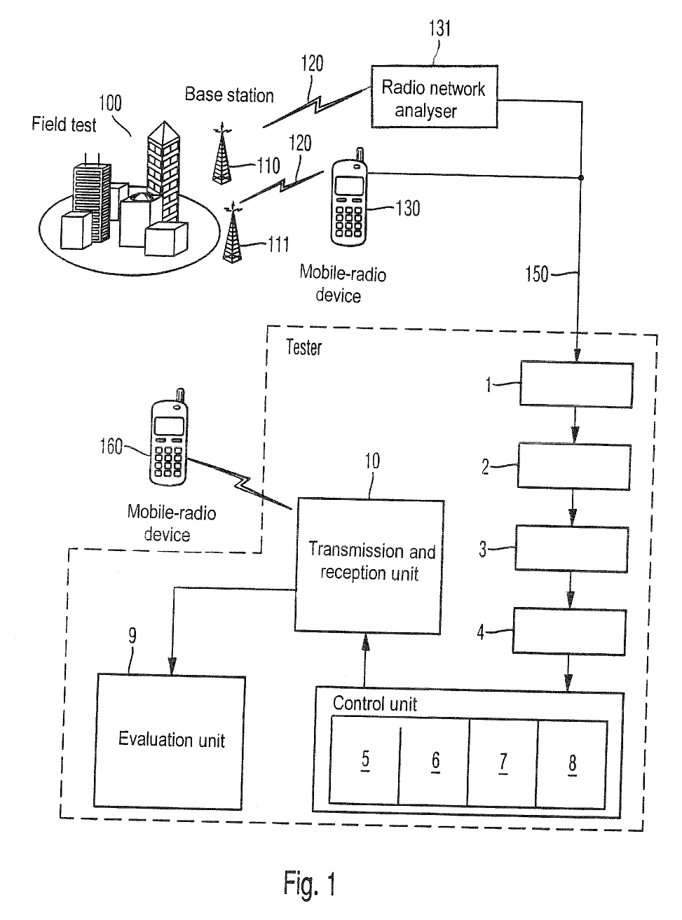

FIG. 1 shows the entire procedure with the example of a mobile-radio device test under real radio conditions from the preparation of signal sequences of several base stations 110, 111 through the recording of a real radio field during a test run, the read-in and processing of the signal sequences, the control of the transmission channels and the evaluation of the signals transmitted back from the mobile-radio device under test.

The radio field of a mobile radio network 120 is composed of the broadcast signal sequences of one or more base stations 110, 111. The signal sequences can originate from base stations of the same or also different mobile-radio operators, they can provide different signal powers and can also be incomplete. The composition of the radio field changes with place and time.

A mobile-radio device 130 prepared for the recording receives these signal sequences continuously, evaluates them with regard to signal power and association with a mobile-radio operator and transmits signals back to a base station, that is to say, it books in to the base station. Data relating to the connection are recorded using an interface of the mobile-radio device 130. Accordingly, the mobile-radio device 130 and base station exchange signalisation messages according to a mobile-radio standard, for example, in order to register in a network or set up a conversation. If the test mobile-radio device 130 moves, the signal power and the composition of the signals in the radio field change, and it may have to book into cells of another base station as required. Accordingly, during the test run, the test mobile-radio device receives a arbitrarily large number of base stations and enters into interaction with them.

In order to test a mobile-radio device under test 160 under such real conditions, the radio field is measured during a test run by means of the prepared mobile-radio device 130 and/or a network analyzer 131, recorded and conditioned into a form readable by the test device used in the test for replaying the signal sequences. The signal sequences of the base stations are routed via an interface 150 to a read-in unit 1. There, they are conditioned into a readable form and stored. The conditioning comprises the generation of instruction sequences for the control of the test device. Within the selection unit 2, an adjustable number of signal sequences from base stations is selected from the totality of the recorded signal sequences from base stations and marked according to their significance. As a criterion for the significance, for example, the signal power or association with a given mobile-radio standard can be used. Combinations are also possible. This selection forms the test scenario for the mobile-radio device test.

In an editing unit 3, parameters or individual messages in one or more of the selected signal sequences can be modified, supplemented and deleted. Missing signalization procedures, such as booking in or authentication within the network are added in the expansion unit 4.

The signal sequences from base stations selected for the test scenario are now broadcast over the channels of the transmission and reception unit 10. In this context, the allocation unit 5 allocates exactly one signal sequence of one base station at a given time in each case to one channel of the transmission and reception unit.

If the totality of the signal sequences of the base stations exceeds the number of available transmission channels, one or more different signal sequences are re-allocated by the alternating unit 6 after a predetermined time or preferably on demand to one or more of the available channels. The demand can occur, for example, in the case of a so-called handover. For this purpose, for example, the signal of a newly-added neighboring cell, for example, may be required. In this context, particularly important signal sequences of base stations are allocated more frequently to one channel. If fewer signal sequences of base stations are present in the test scenario than transmission channels, the surplus transmission channels remain unoccupied. The occupied and the unoccupied transmission channels can also alternate in time. Influences of the individual transmission channels can be suppressed in this manner.

In the alternation of the allocations, for example, the significance, which was marked for the signal sequences of the individual base stations of the real radio field, can be used. If the signal strength of a signal sequence of each base station is used as the criterion for the significance, a test can be implemented, for example, in each case after the expiry of a pre-defined and/or adjustable time, regarding whether a change has resulted in the rank order starting with the largest signal power. If a change is present, the individual transmission/reception channels of the test device are occupied with the signal sequences of the base stations according to the updated rank order. For this purpose, the signal sequences of the base stations are initially sorted on the basis of signal strength, starting with the largest signal strength. Several criteria can also be combined for the marking with regard to significance. For example, it is possible to form several groups, wherein only the signal sequences of base stations, which are associated with a given mobile-radio standard, belong to one group in each case. For instance, if mobile-radio signals in the 1800 MHz network and in the 900 MHz network are received, the 1800 MHz network forms one group and the 900 MHz network forms a second group. Sorting on the basis of the measured signal strength is implemented within these two groups. In the allocation of the signal sequences of individual base stations to the available transmission channels of the test device, it is then possible, for example, to select either that at least one signal sequence must be present from both groups, for example, in order to establish by constraint the existence of a network-external signal. Alternatively, a restriction to only one group may also be desirable, so that only the signal sequence of this one group is allocated to the available transmission/reception channels corresponding to the rank order of significance.

In this context, the new allocation can be implemented in each case after a predefined time interval in order to avoid abrupt changes of the allocations. Alternatively, it is also possible to implement a re-allocation to the transmission/reception channels directly with every updating of the sequence, which results from the measured signal strengths.

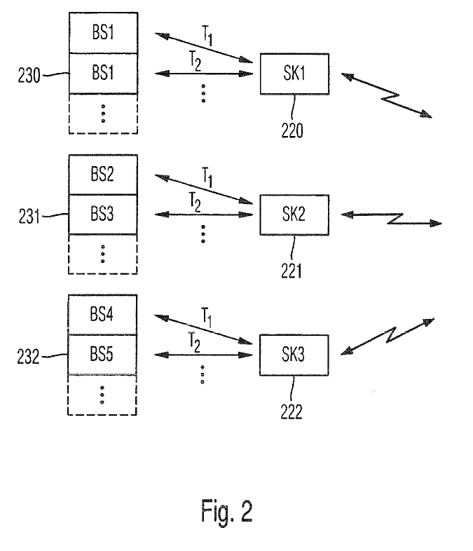

One possible pattern of the time-variable allocation of the totality of the signal sequences of the base stations of a test scenario to the channels of the tester is illustrated in FIG. 2.

In order to model the real radio field in a particularly accurate manner, the signal power unit 7 controls the transmission power of each signal sequence corresponding to the recorded transmission power values. The time sequence of the signals within a signal sequence is controlled by the time control unit 8.

The mobile-radio device under test 160 therefore receives a realistic radio field, processes and interprets the signals and transmits back response signals. These are picked up by the transmission and reception unit 10 and processed in the evaluation unit 9.

FIG. 2 shows an example of the temporal alternation of the allocation between available transmission channels and the signal sequences of the base stations of the test scenario.

The illustrated mobile radio tester comprises three transmission channels 220, 221, 222. The signal sequences of the base stations BS1, BS2, BS3, BS4 and BS5 form the test scenario. Within the time interval T1, the signal sequence of the base station BS1 is allocated to the transmission channel SK1 220; the signal sequence of the base station BS2 to the transmission channel SK2 221; and the signal sequence of the base station BS4 to the transmission channel SK3 222. In the subsequent time interval T2, the allocation alternates in such a manner that the signal sequence of the base station BS1 continues to be allocated to the transmission channel SK1 220; the signal sequence of the base station BS2 to the transmission channel SK2 221; and the signal sequence of the base station BS5 is allocated to the transmission channel SK3 222. The special significance of the signal sequence of the base station BS1, for example, as the base station with the greatest signal strength, is taken into consideration in that it is transmitted both during the time interval T1 and also T2.

If further signal sequences of one or more base stations are transmitted, these can be added to the list of signal sequences from base stations to be transmitted on transmission channel SK1 230, to the list of signal sequences from base stations to be transmitted on transmission channel SK2 231 and to the list of signal sequences from base stations to be transmitted on transmission channel SK3 232, and the test can be prolonged by one time interval T3.

The invention is not restricted to the exemplary embodiment presented. In particular, the individual features of the exemplary embodiment can be combined with one another.

1. A method for testing a mobile-radio device using a test device comprising the following method steps:
generating typical mobile-telephony signal sequences of several base stations from data determined in an existing radio field;
allocating the signal sequence in each case of one base station in each case to one of several transmission/reception channels of the test device;
temporally alternating the allocation of the signal sequence of at least one of the base stations to at least one of the several transmission channels of the test device; and
analyzing the signals transmitted back from the mobile-radio device under test,
wherein the signal sequence of a base station is marked according to its significance, and
wherein a temporal alternation of the allocation of at least one of the signal sequences of the several base stations to at least one of the several transmission channels of the test device is implemented dependent upon the significance of the signal sequence.

2. The method according to claim 1,
wherein the typical mobile-telephony signal sequences are generated from a real radio field recorded during a test run or a radio field generated in a laboratory.

3. The method according to claim 1,
wherein radio scenarios are recorded using a radio network analyzer and/or a test mobile-radio device.

4. The method according to claim 1,
wherein the signal sequences of individual base stations are selected from the totality of the signal sequences.

5. The method according to claim 4,
wherein, in each case, the signal sequences of those base stations, which provide the largest transmission power, are allocated to the transmission/reception channels of the test device.

6. The method according to claim 1,
wherein parts of the signal sequences of individual base stations are changed.

7. The method according to claim 1,
wherein the signal powers of the recorded signal sequences are reproduced.

8. The method according to claim 1,
wherein the signal sequences are transmitted in their recorded time sequence.

9. A system for testing a mobile-radio device, said system comprising:
a read-in unit for reading in and storage of typical mobile-telephony signal sequences;
a tester with several transmission/reception channels;
an allocation unit for the allocation of signals in each case of one base station to one of the several transmission channels in the tester;
an alternating unit, which controls the temporal alternation of the allocation of the signal sequence of at least one of the several base stations to at least one of the several transmission channels of the test device; and
an evaluation unit for the analysis of the messages transmitted back from the mobile-radio device under test,
wherein the tester comprises a selection unit for marking a significance of the signal sequences, and the alternating unit is set up in such a manner that the temporal alternation of the allocation is implemented dependent upon the significance of the signal sequence.

10. The system according to claim 9,
wherein the system contains a selection unit, which is set up in such a manner that the signal sequences of individual base stations are selected from the totality of the typical mobile-telephony signal sequences and marked according to their significance.

11. The system according to claim 9,
wherein an editing unit is set up in such a manner that parts of the signal sequences of individual base stations can be changed.

12. The system according to claim 9,
wherein a correction unit is set up in such a manner that signalisation procedures are added to the recorded signal sequence.

13. The system according to claim 9,
further comprising a time-control unit, which is set up in such a manner that it controls the transmission of the signals of a typical mobile-telephony signal sequence according to their recorded time sequence.

14. The method according to claim 2,
wherein radio scenarios are recorded using a radio network analyzer and/or a test mobile-radio device.

15. The method according to claim 2,
wherein the signal sequences of individual base stations are selected from the totality of the signal sequences.

16. The method according to claim 15,
wherein, in each case, the signal sequences of those base stations, which provide the largest transmission power, are allocated to the transmission/reception channels of the test device.

17. The method according to claim 2,
wherein parts of the signal sequences of individual base stations are changed.

18. The system according to claim 10,
wherein an editing unit is set up in such a manner that parts of the signal sequences of individual base stations can be changed.

19. The system according to claim 10,
wherein a correction unit is set up in such a manner that signalisation procedures are added to the recorded signal sequence.

20. The system according to claim 10,
further comprising a time-control unit, which is set up in such a manner that it controls the transmission of the signals of a typical mobile-telephony signal sequence according to their recorded time sequence.
